(19) United States
(12) Patent Application Publication
(10) Pub. No.: US 2007/0234671 A1
(43) Pub. Date: Oct. 11, 2007

(54) Corrugated Backing, Spacing, and Bracing Strips and Related Wall, Floor, and Roof Frame Assemblies

(76) Inventor: James Alan Klein, Bellevue, WA (US)

Correspondence Address: THOMAS LOOP, P.O. BOX 21466, SEATTLE, WA, 98111, US

(21) Appl. No.: 11/277,408

(22) Filed: Mar. 24, 2006

(51) Int. Cl. E06B 3/54

(52) U.S. Cl. 52/474

(57) ABSTRACT

Corrugated framing elements adapted for use as a backing, spacing, or cross-connecting bracing member in a wall, floor, or roof frame-assembly of a building are disclosed herein. In one embodiment, an elongated framing element comprises an elongated flat sheet-metal strip that includes at least a first lengthwise and inwardly protruding corrugated groove, wherein the first inwardly protruding corrugated groove includes a plurality of laterally spaced first apertures sized and positioned to receive the plurality of studs.

### TECHNICAL FIELD

The present invention relates generally to wall, floor, and roof assemblies, and more particularly, to spacing, bracing, and backing members used in conjunction with the erection and construction of stud wall, floor joist, and roof truss frame-assemblies.

### BACKGROUND OF THE INVENTION

The framing associated with building walls, floors, and roofs has historically been assembled from wood members, including wood studs and beams. In more recent years, however, and at least in the United States, the use of metal studs together with confronting channeled track members has gained wide acceptance, especially in new commercial buildings such as office buildings and hospitals. Generally speaking, metal studs and track members are stronger, more resistant to fire, and economical than their wooden counterparts.

Metal studs are typically formed of galvanized sheet-metal bent to encompass a cross sectional area having nominal dimensions of two inches by four inches. To conform to modern architectural plans and building code requirements, metal studs are formed of sheet-metal bent into a generally U-shaped cross-section in which a relatively broad central base is flanked by a pair of narrower sides that are bent at right angles relative to the base. The central base typically has a uniform nominal width of either four inches or 3⅝ inches and is commonly referred to as the web. The sides of the U-shaped stud typically extend outwardly from the base a nominal distance of two inches and are commonly referred to as flanges. In order to enhance the structural rigidity of the flanges, the ends of flanges are typically bent over into a plane parallel to and spaced apart from the plane of the web. The turned over edges of the flanges define marginal lips that are typically ¼ to ½ inch in width.

During the framing of building walls, floors, and roofs, it is common practice to position wall studs, floor joists, and roof trusses at regularly spaced apart intervals relative to one another. For example, it is common practice to vertically position wall studs at 16 inch from center intervals. Likewise, it is common practice to horizontally position floor joist and roof trusses at 16 inch from center intervals as well. In addition, and after the studs, joists and trusses have been properly positioned, there is often a need for the studs, joists and trusses to be transversely braced together, thereby providing enhanced structural rigidity to the frame-assembly. For example, studs over eight feet in length are generally transversely braced together to ensure adequate lateral stability of the wall structure. Exemplary devices that assist with the proper spacing and bracing of at least metal studs include those devices disclosed in U.S. Pat. No. 1,867,449 to Ecket et al. (discloses a metal fire block, bridging, and bracing element), U.S. Pat. No. 5,274,973 to Liang (discloses a notched stud spacer and mounting system), U.S. Pat. No. 6,021,618 to Elderson (discloses a notched stud spacer), U.S. Pat. No. 6,164,028 to Hughes (discloses a metallic bridging member), and U.S. Pat. No. 6,983,569 to Rosenberg (discloses a notched stud spacer and bracing member together with a wall framing system).

In other situations, a backing member is required between adjacent parallel studs, wherein the backing member provides sufficient structural rigidity to allow for the installation and support of wall-mounted fixtures such as, for example, hand rails and grab bars. Backing members are often shaped from plywood so as to fit between adjacent studs. The number and placement of backing plywood pieces is determined by how much of the framework needs backing. In addition to plywood pieces, other exemplary backing devices include those devices disclosed in U.S. Pat. No. 4,453,362 to Rodgers (discloses an expandable and retractable metal backing member), U.S. Pat. No. 4,658,556 to Jenkins (discloses an expandable and retractable metal blocking and backing member), U.S. Pat. No. 5,189,857 to Herren et al. (discloses a cross-connecting bridging or backing member formed from a metal channel member), and U.S. Pat. No. 6,260,318 to Herren (discloses a bracing, blocking, and backing member formed from a metal member and configured to fit within the spaced apart region between adjacent studs).

Although significant advances have been made over the years with respect to the development of backing, spacing and bracing elements and systems used in conjunction with the erection and construction of stud wall, floor joist, and roof truss frame-assemblies, there is still a need in the art for new and improved framing elements that can be used as a backing, spacing, and cross-connecting bracing member in a wall, floor, or roof frame-assembly of a building. The present invention fulfills these needs and provides for further related advantages.

### SUMMARY OF THE INVENTION

In a first embodiment, the present invention is directed a framing element adapted for use as a backing, spacing, or cross-connecting bracing member in a wall, floor, or roof frame-assembly of a building. In this embodiment, the framing element comprises an elongated flat sheet-metal strip having an inner surface and an outer surface. The sheet-metal strip also includes at least a first inwardly protruding lengthwise corrugated groove, wherein the first corrugated groove is segmented by a plurality of uniform and equally spaced apart first apertures thereby defining a plurality of uniform and equally spaced apart first corrugated groove segments. Each of the plurality of first apertures is sized and configured to receive a flange of a sheet-metal stud, and each of the plurality of groove segments is sized to span between adjacent studs.

In another embodiment, the elongated sheet-metal framing element includes a second lengthwise and inwardly protruding groove. The second lengthwise groove is positioned adjacent and substantially parallel to the first lengthwise corrugated groove. Similar to the first corrugated groove, the second corrugated groove includes (i) a plurality of laterally spaced second apertures sized and positioned to receive the flange of the sheet-metal stud, the second apertures thereby being adjacent to the first apertures, and (ii) a plurality of inwardly protruding second corrugated groove segments sized and positioned to span between the adjacent studs, the second corrugated groove segments thereby being adjacent to the first corrugated groove portions.

In another embodiment, the present invention is directed to a frame-assembly of a building that comprises: a plurality of uniform and laterally space apart studs, wherein each of the plurality of studs has an outer flange or side surface coplanar with the outer flange or side surfaces of the other studs; and an elongated flat sheet-metal strip having an inner surface and an outer surface, wherein the elongated strip is positioned flush across the plurality of studs such that the inner surface of the strip abuts to the outer flange or side surfaces of the plurality of studs, and wherein the sheet-metal strip includes at least a first inwardly protruding lengthwise corrugated groove, wherein the first corrugated groove is segmented by a plurality of uniform and equally spaced apart first apertures thereby defining a plurality of uniform and equally spaced apart first corrugated groove segments, and wherein the plurality of studs are received into the plurality of first apertures.

These and other aspects of the present invention will become more evident upon reference to the following detailed description and attached drawings. It is to be understood, however, that various changes, alterations, and substitutions may be made to the specific embodiments disclosed herein without departing from their essential spirit and scope. In addition, it is to be further understood that the drawings are intended to be illustrative and symbolic representations of certain exemplary embodiments of the present invention and as such they are not necessarily drawn to scale. Finally, it is expressly provided that all of the various references cited herein are incorporated herein by reference in their entireties for all purposes.

### BRIEF DESCRIPTION OF THE DRAWINGS

The drawings are intended to be illustrative and symbolic representations of certain exemplary embodiments of the present invention and as such they are not necessarily drawn to scale. In addition, and for purposes of clarity, like reference numerals have been used to designate like features throughout the several views of the drawings.

FIG. 1 illustrates a side perspective view of a framing element in accordance with an embodiment of the present invention, wherein the framing element comprises an elongated sheet-metal strip having a plurality of uniformly spaced apertures positioned along a first lengthwise and segmented corrugated groove.

FIG. 2 illustrates an end view of the framing element of FIG. 1 taken along line 2-2.

FIG. 3 illustrates a side perspective view of a wall assembly in accordance with an embodiment of the present invention, wherein the wall assembly comprises a plurality of uniform metal upright studs mounted at laterally spaced intervals and an elongated sheet-metal framing element positioned flush across the outer flange surfaces of the plurality of studs, wherein the elongated sheet-metal framing element includes at least a first lengthwise inwardly protruding corrugated groove, and wherein the first inwardly protruding corrugated groove includes (i) a plurality of laterally spaced first apertures sized and positioned to receive the plurality of studs, and (ii) a plurality of inwardly protruding first corrugated groove segments sized and positioned to span between the plurality of studs.

FIG. 4 illustrates a side perspective view of a framing element in accordance with an embodiment of the present invention, wherein the framing element comprises an elongated sheet-metal strip having first and second lengthwise and substantially parallel corrugated grooves, with each groove being segmented and having a plurality of uniformly spaced apertures sized and configured to receive a stud.

FIG. 5 illustrates an end view of the framing element of FIG. 4 taken along line 5-5.

FIG. 6 illustrates a side perspective view of a wall assembly in accordance with an embodiment of the present invention, wherein the wall assembly comprises: a plurality of uniform metal upright studs mounted at laterally spaced intervals; an elongated sheet-metal framing element positioned flush across the outer flange surfaces of the plurality of studs; wallboard positioned flush across the outer flange surfaces of the plurality of studs and the outer surface of the framing element; and a wall-mounted fixture connected to the framing element.

### DETAILED DESCRIPTION OF THE INVENTION

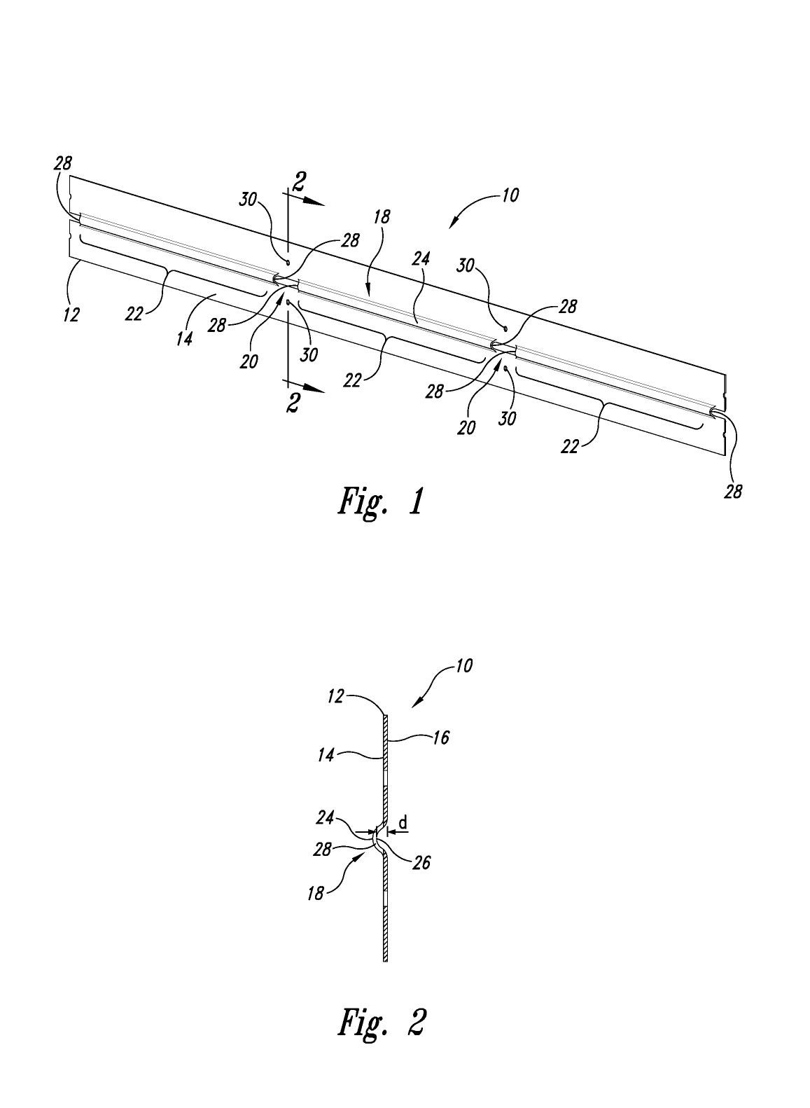

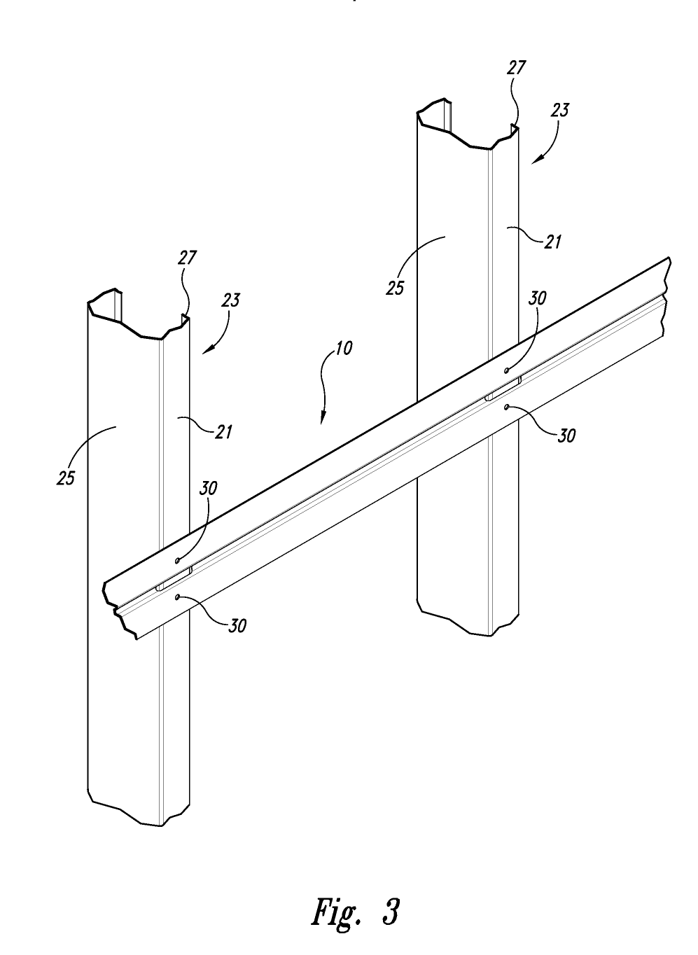

Referring now to the drawings wherein like reference numerals designate identical or corresponding elements, and more particularly to FIGS. 1-3, the present invention in one embodiment is directed to a framing element 10 adapted for use as a backing, spacing, or cross-connecting bracing member in a wall, floor, or roof frame-assembly of a building. In this first embodiment, the framing element 10 comprises an elongated flat sheet-metal strip 12 having an inner surface 14 and an outer surface 16. For purposes of cost-effective manufacturing, the sheet-metal strip 12 is preferably made in the shape of an elongated rectangle cut from a sheet (8, 10, 12, 14, or 16 feet long) of galvanized steel (16, 18, 20 or 25 gage). As shown, the sheet-metal strip 12 includes at least a first inwardly protruding lengthwise corrugated groove 18. The first corrugated groove 18 is preferably made by standard cold forming and bending techniques as is appreciated by those skilled in the art. The first corrugated groove 18 is further segmented by a plurality of uniform and equally spaced apart first apertures 20, thereby defining a plurality of uniform and equally spaced apart first corrugated groove segments 22. As best shown in FIG. 3, each of the plurality of first apertures 20 is sized and configured to receive a flange 21 of a standard sheet-metal stud 23. The plurality of first apertures 20 are preferably made by punching a plurality of linearly spaced apart slots into the sheet-metal strip 12 prior to bending and forming of the first inwardly protruding lengthwise corrugated groove 18. The plurality of linearly spaced apart slots thus define the plurality of first apertures 20.

Because the first corrugated groove 18 is preferably made by conventional form bending techniques applied to a piece of sheet-metal, the first corrugated groove 18 further defines(as best shown in FIG. 2) (i) a first segmented ridge-line 24 positioned on the inner surface 14 of the sheet-metal strip 12 along the apex of the first corrugated groove 18, and (ii) a corresponding first segmented valley-line 26 positioned on the outer surface 16 of the sheet-metal strip 12 opposite the ridge-line 24. As best shown in FIG. 2, the valley-line 26 is preferably positioned a selected parallel distance “d” away from the plane defined by the outer surface 16 of the flat-sheet metal strip 12. The selected parallel distance “d” preferably ranges from about ⅛ to about ¾ of an inch, and more preferably from about ¼ to about ½ of an inch, and even more preferably the selected distance “d” is about ⅜ of an inch. Moreover, and because form bending is preferably used to make the first corrugated groove 18, each of the plurality of first corrugated groove segments 22 has generally curved or c-shaped ends 28. Finally, the sheet-metal strip 12 also preferably includes a plurality fastener receiving holes 30 positioned adjacent to the plurality of first apertures 20 such that the framing element 10 can be securely fastened to the flange 21 of the sheet-metal stud 23 when the stud 23 is received into one of the first apertures 20.

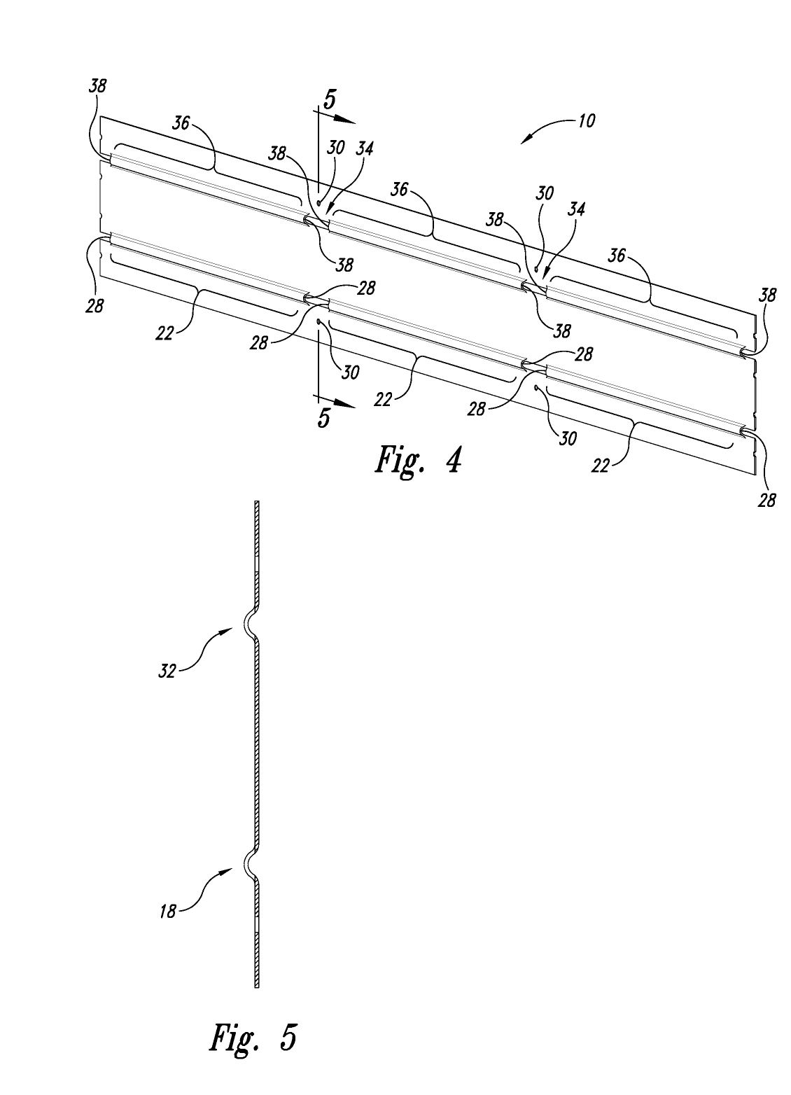

In another embodiment and with reference to FIGS. 4-6, the framing element 10 of the present invention further comprises a second inwardly protruding lengthwise corrugated groove 32 positioned adjacent and parallel to the first corrugated groove 18. As shown, the second corrugated groove 32 is likewise segmented by a plurality of uniform and equally spaced apart second apertures 34, thereby defining a plurality of uniform and equally spaced apart second corrugated groove segments 36. Like the plurality of first apertures 20, each of the plurality of second apertures 34 is sized and configured to receive the flange 21 of the sheet-metal stud 23. Moreover, and because form bending is also preferably used to make the second corrugated groove 32, each of the plurality of second corrugated groove segments 36 has generally c-shaped ends 38. In general, the first and second corrugated grooves 18, 32 have the same dimensions and shape.

Thus, and as best shown in FIG. 4, the c-shaped ends 28 of the first groove segments 22 are in perpendicular alignment relative to the c-shaped ends 38 of the second groove segments 36. As such, when the sheet-metal stud 23 is received into one of the plurality of first and second apertures 20, 33, the c-shaped ends 28, 38 of the first and second groove segments 22, 36 contact a web portion 25 and a lip portion 27 of the sheet-metal stud 23. In preferred embodiments, the c-shaped ends 28, 38 of the first and second groove segments 22, 36 are of substantially the same shape and profile.

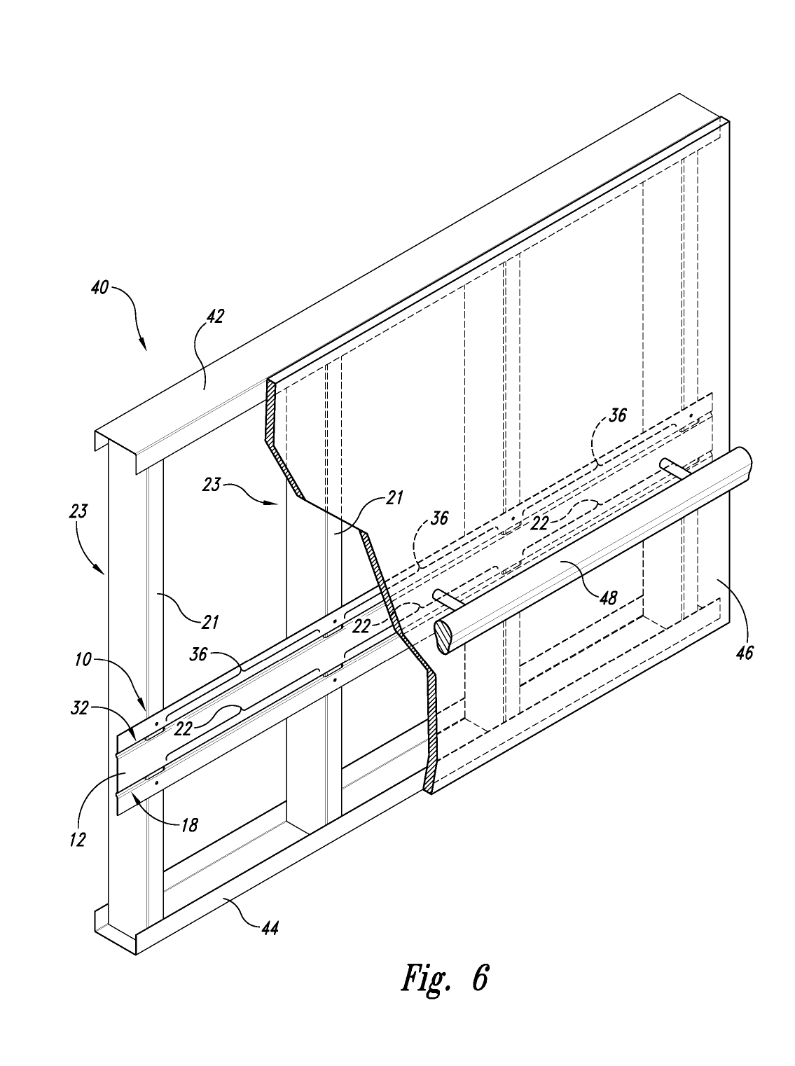

As best shown in FIG. 6, the present invention is also directed to a frame-assembly 40 of a building, wherein the frame-assembly 40 comprises a plurality of uniform and laterally space apart studs 23 positioned within confronting header and footer tracks 42, 44, and an elongated flat sheet-metal strip 12 having an inner surface (not shown) and an outer surface 16. In this embodiment, each of the plurality of studs 23 has an outer flange 21 or side surface that is coplanar with the outer flange 21 or side surfaces of the other studs 23. The elongated sheet-metal strip 12 is positioned flush across the plurality of studs 23 such that the inner surface (not shown) of the strip 12 abuts to the outer flange 21 or side surfaces of the plurality of studs 23. The sheet-metal strip 12 includes at least a first inwardly protruding lengthwise corrugated groove 18 (and as shown a second inwardly protruding lengthwise corrugated groove 32). The first corrugated groove 18 is segmented by a plurality of uniform and equally spaced apart first apertures 20 thereby defining a plurality of uniform and equally spaced apart first corrugated groove segments 22. Similarly, the second corrugated groove 32 is segmented by a plurality of uniform and equally spaced apart second apertures 34 thereby defining a plurality of uniform and equally spaced apart second corrugated groove segments 36. As shown, the plurality of studs 23 are received into the plurality of first and second apertures 20, 36. Finally, wallboard 46 is positioned over the plurality of studs 23 and a wall-mounted fixture 48 is attached to the elongated flat sheet-metal strip 12.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing descriptions, and all changes that come within the meaning and range of equivalency of the claims are to be embraced within their scope.

What is claimed is:

1. A framing element adapted for use as a backing, spacing, or cross-connecting bracing member in a wall, floor, or roof frame-assembly of a building, the framing element comprising an elongated flat sheet-metal strip having an inner surface and an outer surface, wherein the sheet-metal strip includes at least a first inwardly protruding lengthwise corrugated groove, wherein the first corrugated groove is segmented by a plurality of uniform and equally spaced apart first apertures thereby defining a plurality of uniform and equally spaced apart first corrugated groove segments, and wherein each of the plurality of first apertures is sized and configured to receive a flange of a sheet-metal stud.

2. The framing element of claim 1 wherein the first corrugated groove further defines (i) a first segmented ridge-line positioned on the inner surface of the sheet-metal strip along the apex of the first corrugated groove, and (ii) a corresponding first segmented valley-line positioned on the outer surface of the sheet-metal strip opposite the ridge-line, and wherein the valley-line is positioned a selected parallel distance away from the plane defined by the inner surface of the flat-sheet metal strap.

3. The framing element of claim 2 wherein each of the plurality of first corrugated groove segments has c-shaped ends.

4. The framing element of claim 1, further comprising a second inwardly protruding lengthwise corrugated groove positioned adjacent and parallel to the first corrugated groove, wherein the second corrugated groove is segmented by a plurality of uniform and equally spaced apart second apertures thereby defining a plurality of uniform and equally spaced apart second corrugated groove segments, and wherein each of the plurality of second apertures is sized and configured to receive the flange of the sheet-metal stud.

5. The framing element of claim 4 wherein each of the plurality of second corrugated groove segments has c-shaped ends.

6. The framing element of claim 5 wherein the c-shaped ends of the first groove segments are in perpendicular alignment relative to the c-shaped ends of the second groove segments.

7. The framing element of claim 6 wherein the c-shaped ends of the first and second groove segments contact a web portion and a lip portion of the sheet-metal stud, when the sheet-metal stud is received into one of the plurality of first and second apertures.

8. A frame-assembly of a building, comprising:
a plurality of uniform and laterally space apart studs, wherein each of the plurality of studs has an outer flange or side surface coplanar with the outer flange or side surfaces of the other studs; and
an elongated flat sheet-metal strip having an inner surface and an outer surface, wherein the elongated strip is positioned flush across the plurality of studs such that the inner surface of the strip abuts to the outer flange or side surfaces of the plurality of studs, and wherein the sheet-metal strip includes at least a first inwardly protruding lengthwise corrugated groove, wherein the first corrugated groove is segmented by a plurality of uniform and equally spaced apart first apertures thereby defining a plurality of uniform and equally spaced apart first corrugated groove segments, and wherein the plurality of studs are received into the plurality of first apertures.

9. The frame-assembly of claim 8 wherein the first corrugated groove further defines (i) a first segmented ridge-line positioned on the inner surface of the sheet-metal strip along the apex of the first corrugated groove, and (ii) a corresponding first segmented valley-line positioned on the outer surface of the sheet-metal strip opposite the ridge-line, and wherein the valley-line is positioned a selected parallel distance away from the plane defined by the inner surface of the flat-sheet metal strap.

10. The frame-assembly of claim 9 wherein each of the plurality of first corrugated groove segments has c-shaped ends.

11. The frame-assembly of claim 8, further comprising a second inwardly protruding lengthwise corrugated groove positioned adjacent and parallel to the first corrugated groove, wherein the second corrugated groove is segmented by a plurality of uniform and equally spaced apart second apertures thereby defining a plurality of uniform and equally spaced apart second corrugated groove segments, and wherein the plurality of studs are received into the plurality of second apertures.

12. The frame-assembly of claim 11 wherein each of the plurality of second corrugated groove segments has c-shaped ends.

13. The frame-assembly of claim 12 wherein the c-shaped ends of the first groove segments are in perpendicular alignment relative to the c-shaped ends of the second groove segments.
